(19) United States
(12) Patent Application Publication
(10) Pub. No.: US 2021/0368280 A1
(43) Pub. Date: Nov. 25, 2021

(54) METHOD FOR OPERATING A HEARING AID AND HEARING AID

(71) Applicant: Sivantos Pte. Ltd., Singapore (SG)

(72) Inventor: Sebastian Best, Erlangen (DE)

(21) Appl. No.: 17/322,084

(22) Filed: May 17, 2021

(30) Foreign Application Priority Data
May 20, 2020 (DE) 102020206367.2

(51) Int. Cl. H04R 25/00

(52) U.S. Cl. CPC H04R 25/407; H04R 25/453

(57) ABSTRACT

A method for operating a hearing aid, in particular a hearing aid device, which includes a directional microphone, an interference noise suppression unit, and a receiver for outputting an output sound. Sound is acquired from a preferred direction and conducted to the interference noise suppression unit by way of the directional microphone. A counter sound signal is created and conducted to the receiver by the interference noise suppression unit. The counter sound signal is output as output sound by way of the receiver. The counter sound signal is created in such a way that upon superposition of the output sound with the sound, destructive acoustic interference at least partially takes place. There is also described a hearing aid and the use of a hearing aid.

### CROSS-REFERENCE TO RELATED APPLICATION

This application claims the priority, under 35 U.S.C. § 119, of German Patent Application DE 10 2020 206 367.2, filed May 20, 2020; the prior application is herewith incorporated by reference in its entirety.

### BACKGROUND OF THE INVENTION

### Field of the Invention

The method relates to a method for operating a hearing aid and a hearing aid. The hearing aid includes each of a directional microphone, an interference noise suppression unit, and a receiver for output of an output sound. The hearing aid is preferably a hearing aid device.

Persons who suffer from a reduction of the sense of hearing typically use a hearing aid device. Ambient sound is usually acquired in this case by means of an electromechanical sound transducer. The acquired electrical signals are processed by means of an amplifier circuit and introduced into the auditory canal of the person by means of a further electromechanical transducer in the form of a receiver. The acquired sound signals are usually additionally processed, for which purpose a signal processor of the amplifier circuit is usually used. The amplification is adapted here to a possible loss of hearing of the hearing aid wearer.

If the ambient sound additionally includes sound of an interference source, i.e., an undesired source, in this case, this is also acquired and introduced in amplified form into the auditory canal of the person because of the amplification. It is thus made more difficult for the person to identify the desired components in the sound emitted into the auditory canal. To avoid this, a directional microphone is usually used. This is set to a desired sound source, so that only the sound emitted thereby is acquired by means of the electromechanical sound transducer. Therefore, only this component of the ambient sound is emitted in amplified form into the auditory canal by means of the amplifier circuit. However, it is also possible here that the sound emitted from the interference source additionally penetrates directly into the auditory canal of the person, so that it is perceived by the person, although not in amplified form. In order that a differentiation is possible for the person, the amplification factor of the amplifier circuit is therefore also increased, which can result in comfort losses and fatigue of the person.

Furthermore, headphones having active interference noise suppression are known. The headphones typically include a microphone, by means of which the ambient sound is acquired and conducted to an interference noise suppression unit, by means of which a counter sound signal is created. This is conducted to a receiver of the headphone, so that an output sound is output into the auditory canal. This is overlaid with the ambient sound penetrating into the auditory canal, so that destructive acoustic interference takes place. As a result, the ambient sound is not perceptible or is only perceptible to a reduced extent for the person. Furthermore, additional sound, usually in the form of music, is output into the auditory canal using the receiver. Because of the interference noise suppression, it is possible to output the additional sound at reduced volume, wherein it can nonetheless be perceived in an improved manner for the person. Since the sound to be perceived by the person, namely the additional sound, is output by means of the headphone itself, it is necessary to completely eliminate the ambient sound by means of the destructive acoustic interference in the auditory canal. As a result, the person essentially cannot perceive processes in their surroundings, at least on the basis of the respective ambient sound.

### BRIEF SUMMARY OF THE INVENTION

It is accordingly an object of the invention to provide a method and a hearing device (hearing aid) which overcome the above-mentioned disadvantages of the heretofore-known devices and methods of this general type and which provide for a particularly suitable method for operating a hearing aid and a particularly suitable method for operating a hearing aid system and also a particularly suitable hearing aid, wherein in particular comfort and/or speech comprehension is enhanced.

With the above and other objects in view there is provided, in accordance with the invention, a method of operating a hearing device, which includes a directional microphone, an interference noise suppression unit, and a receiver for outputting an output sound. The novel method comprises the following method steps:

acquiring sound from a preferred direction by the directional microphone and conducting the sound to the interference noise suppression unit;

generating a counter sound signal by the interference noise suppression unit and conducting the counter sound signal to the receiver; and

outputting the counter sound signal as an output sound by way of the receiver;

wherein the counter sound signal is generated such that, upon superposition of the output sound with the sound acquired with the directional microphone, causes at least partial destructive acoustic interference.

The method is used for operating a hearing device, here: hearing aid, for short. For example, the hearing aid is a headphone or comprises a headphone. However, the hearing aid is particularly preferably a hearing aid device. The hearing aid device is used to assist a person suffering from a reduction of the sense of hearing. In other words, the hearing aid device is a medical device, by means of which, for example, a partial hearing loss is compensated for. The hearing aid device is, for example, a “receiver-in-the-canal” hearing aid device (RIC), an in-ear hearing aid device, such as an “in-the-ear” hearing aid device, an “in-the-canal” hearing aid device (ITC), or a “complete-in-canal” hearing aid device (CIC), a spectacle hearing aid, a pocket hearing aid device, a bone vibrator hearing aid device, or an implant. The hearing aid device is particularly preferably a behind-the-ear hearing aid device, which is worn behind a pinna.

The hearing aid is provided and configured to be worn on the human body. In other words, the hearing aid preferably comprises a holding device, by means of which fastening on the human body is possible. If the hearing aid is a hearing aid device, the hearing aid is provided and configured, for example, to be arranged behind-the-ear or inside an auditory canal. In particular, the hearing aid is wireless and is provided and configured for the purpose of being introduced at least partially into an auditory canal. The hearing aid particularly preferably comprises an energy accumulator, by means of which an energy supply is provided.

The hearing aid includes a directional microphone. The directional microphone is used to acquire sound from a preferred direction. During operation, the (acoustic) sound is converted by means of the directional microphone into an electrical signal, which is referred to hereinafter as the sound signal. The sound from the preferred direction is acquired solely or at least in an enhanced manner by means of the directional microphone. In contrast, if further sound is incident on the directional microphone, for example from the direction opposite thereto, this further sound is not acquired or is only acquired to a reduced extent, so that this represents no or only a comparatively minor component of the sound signal. To create the directional effect of the directional microphone, i.e., the preferred acquisition of the sound from the preferred direction, it expediently includes multiple individual microphones, which are each designed as an omnidirectional microphone, for example. The directional effect is implemented here by means of a corresponding evaluation of the electrical signals created by means of the microphones.

Furthermore, the hearing aid includes an interference noise suppression unit, which is in particular designed as active (ANC; “active noise canceling”). The interference noise suppression unit is in this case capable of, in particular provided and configured for, creating a counter sound signal, in particular to the sound signal. The hearing aid also includes a receiver, which is preferably designed like a loudspeaker. In other words, the receiver is an electromechanical transducer. The receiver is used to output an output sound, thus to output soundwaves, which thus takes place acoustically. The receiver is suitably arranged here in such a way that the output sound is emitted into an auditory canal of a wearer of the hearing aid, thus the user, when the hearing aid is worn in the intended state.

The method provides that sound is acquired from the preferred direction by means of the directional microphone. The acoustic soundwaves of the sound are thus converted into the electrical sound signal. The preferred direction is here, for example, a single direction, and only the sound which is incident on the directional microphone around a cone around the preferred direction is acquired, so that the sound signal only includes these components of the ambient sound. In other words, only the part of the ambient sound is acquired by means of the directional microphone and converted into the sound signal which is incident from a spatial region on the directional microphone, wherein the spatial region is a cone, the axis of which goes through the directional microphone and is parallel to the preferred direction. In particular, the spatial angle is less than 90°, 45°, 30°, 20°, or 10° here. Alternatively, the spatial region from which the sound originates has the form of an anticardioid. The sound signal created by means of the directional microphone is conducted to the interference noise suppression unit. In particular, the directional microphone and the interference noise suppression unit have a signaling connection to one another for this purpose, for example by means of a cable or a conductor track.

A counter sound signal is created by means of the interference noise suppression unit, which is thus also an electrical signal. The counter sound signal is conducted to the receiver, for example directly or via further components. The receiver is thus at least partially impinged by means of the counter sound signal or at least a signal which is based on the counter sound signal. The counter sound signal is thus output as output sound by means of the receiver. In other words, the counter sound signal is converted into a sound, namely the output sound. The output sound is used for the destructive acoustic interference with the sound. In other words, when the output sound is superimposed with the sound, destructive acoustic interference at least partially takes place. The output sound is suitable, in particular provided and configured, for this purpose. The destructive acoustic interference expediently takes place at the ear or in the ear canal/auditory canal of the user. For this purpose, the hearing aid is expediently designed accordingly. In other words, both the sound and also the output sound, in the intended state of the hearing aid, thus when it is worn by the person, reach their auditory canal, and the output sound and the sound are superimposed. The destructive acoustic interference takes place here, so that for the person who wears the hearing aid, thus for the user, the sound is not perceptible or is at least only perceptible to a greatly reduced extent. The counter sound signal is created here in such a way that the output sound resulting therefrom arises. For this purpose, the counter sound signal is expediently phase offset by 180° from the sound signal.

Further sound, thus sound which is not incident from the preferred direction on the directional microphone, and which is incident, for example, from the direction opposite to the preferred direction on the directional microphone, is not attenuated or is only attenuated to a comparatively minor extent upon the superposition with the output sound. Essentially no modification of the further sound preferably takes place here.

Because of the method, sound incident from the preferred direction on the directional microphone and thus the hearing aid is thus not perceived or is only perceived to a comparatively minor extent by the person. In contrast, further components of the ambient sound, thus the sound which is not incident from the preferred direction on the directional microphone, are preferably not attenuated, so that it can be perceived undiminished by the person. It is therefore possible that one or more specific interference sources, which in particular emits or emit the sound, are deliberately suppressed, whereas the rest of the surroundings is still perceptible to the user. It is thus also possible to perceive comparatively soft noises, which enhances comfort and speech comprehension and therefore also safety. Amplification of these noises is not necessary here. Furthermore, it is ensured in the case of only partial closure of the auditory canal by means of the hearing aid and the penetration of the ambient sound into the auditory canal resulting therefrom that the sound is not perceived or is at least perceived with reduced volume. It is therefore not absolutely necessary to seal off the auditory canal, which enhances the comfort of wearing the hearing aid. For example, sound is acquired from multiple preferred directions by means of the directional microphone and conducted to the interference noise suppression unit. It is thus possible to suppress multiple interference sources.

For example, the destructive acoustic interference takes place over a comparatively broad frequency band, expediently over all frequencies perceptible by humans, thus in particular from 20 Hz to 20 000 kHz. However, the destructive acoustic interference particularly preferably takes place in a frequency-selective manner. The counter sound signal is expediently created accordingly for this purpose. In particular, the output sound and thus also the counter sound signal includes an upper (frequency) limit here, so that destructive interference only takes place with the sound, the frequency of which is less than the upper frequency limit. For example, the frequency band is unlimited downward in this case. However, a lower frequency limit is particularly preferably also provided, so that the counter sound signal includes a lower and an upper (frequency) limit. It is thus possible to suppress specific interference sources deliberately, whereas sources of further sound which are also in the preferred direction are also still perceptible by the user. Comfort is thus further enhanced.

The preferred direction is fixedly set, for example. For this purpose, the possible microphones of the directional microphone are, for example, permanently electrically interconnected with one another. However, it is particularly preferably possible to change the preferred direction. This is carried out, for example, by means of manual adjustment. The preferred direction is particularly preferably changed here in dependence on the sound. An adaptive adjustment of the preferred direction takes place for this purpose in particular. The preferred direction is suitably adjusted here in such a way that a specific component of the ambient sound is identified as sound. This sound has specific properties, for example, such as a specific frequency or other properties. For example, the sound is manually or automatically identified in the ambient sound. For this purpose, for example, first a constant hum or the like is identified in the ambient sound, which is induced by the interference source, for example a refrigerator or a pneumatic hammer. The direction from which this sound is incident on the directional microphone is subsequently identified, and this direction is used as the preferred direction. If the position of the interference source with respect to the directional microphone changes, in particular the preferred direction is adapted. The preferred direction is thus adjusted to the current interference source, and it is thus at least partially suppressed.

For example, the hearing aid is only used to suppress the sound for the person. In other words, only the counter sound signal is output by means of the hearing aid. However, a further sound signal is particularly preferably output simultaneously with the counter sound signal by means of the receiver. The output sound thus includes multiple components. The further sound signal is, for example, a piece of music or a soundtrack of a film. As an alternative, the further sound signal is also created by means of the hearing aid itself. For this purpose, a further sound may be acquired and conducted as an audio signal to a corresponding circuit by means of the hearing aid. By means of this circuit, the further sound signal is derived therefrom. In particular, amplification is carried out by means of the circuit, wherein the amplification is carried out in a directionally-selective manner, for example. In other words, the further sound is preferably acquired from a further preferred direction, which in particular has an angle to the preferred direction which is greater than 30° or 45°.

The hearing aid expediently comprises a signal processor, which at least partially assumes the function of the circuit in a suitable manner. The signal processor is, for example, a digital signal processor (DSP) or is implemented by means of analog components. In particular the audio signal, which is generated in particular using the directional microphone, for example a part thereof, or a further microphone, is adapted by means of the signal processor. An A/D converter is expediently arranged between them in this case, if the signal processor is designed as a digital signal processor. The signal processor is adjusted in particular as a function of a parameter set. An amplification in different frequency ranges is specified by means of the parameter set. For example, the amplification factor which is associated with the individual frequency bands differs in different parameter sets. The hearing aid particularly preferably additionally comprises an amplifier, or the amplifier is at least partially formed by means of the signal processor. For example, the amplifier is connected to the signal processor upstream or downstream for signaling.

Because of the further sound signal, a sound source producing the further sound is thus perceptible in amplified form to the user, so that it is possible to compensate for an at least partial hearing loss. However, comprehensibility of the further sound is at least improved for the user.

As noted briefly above, the invention pertains to a hearing device and a corresponding method. The hearing device is generically referred to as a hearing aid and it is a headphone or comprises a headphone. The hearing aid is designed, for example, as a so-called headset here. However, the hearing aid is particularly preferably a hearing aid device. The hearing aid device is used to assist a person suffering from a reduction of the sense of hearing. In other words, the hearing aid device is a medical device, by means of which, for example, a partial hearing loss is compensated for. The hearing aid device is, for example, a “receiver-in-the-canal” hearing aid device (RIC), an in-ear hearing aid device, such as an “in-the-ear” hearing aid device, an “in-the-canal” hearing aid device (ITC), or a “complete-in-canal” hearing aid device (CIC), a spectacle hearing aid, a pocket hearing aid device, a bone vibrator hearing aid device, or an implant. The hearing aid device is particularly preferably a behind-the-ear hearing aid device, which is worn behind a pinna.

The hearing aid furthermore includes a directional microphone, an interference noise suppression unit (NSU), and a receiver. Depending on the design of the hearing aid, the receiver is arrangeable outside or at least partially inside an auditory canal of a user, and when the hearing aid is worn as intended, is arranged therein.

The hearing aid is operated according to a method in which sound is acquired from a preferred direction and conducted to the interference noise suppression unit by means of the directional microphone. A counter sound signal is created by means of the interference noise suppression unit and conducted to the receiver. The counter sound signal is output as output sound by means of the receiver, wherein the counter sound signal is created in such a way that upon superposition of the output sound with the sound, destructive acoustic interference at least partially takes place. The hearing aid preferably includes a control unit, by means of which the method is at least partially carried out. In other words, the control unit is capable of, in particular provided and configured for, carrying out the method.

A hearing aid having a directional microphone is used to create an output sound for at least partial destructive acoustic interference with a sound from a preferred direction upon superposition. The output sound is based on a counter sound signal which is based on the sound acquired by means of the directional microphone from the preferred direction.

The refinements and advantages described in conjunction with the method are also to be transferred accordingly to the hearing aid/use and among one another and vice versa.

Other features which are considered as characteristic for the invention are set forth in the appended claims.

Although the invention is illustrated and described herein as embodied in method for operating a hearing aid and a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a hearing aid;

FIG. 2 shows a method for operating the hearing aid; and

FIG. 3 schematically shows a detail of the hearing aid in simplified form.

Parts corresponding to one another are provided with the same reference signs throughout the figures.

### DETAILED DESCRIPTION OF THE INVENTION

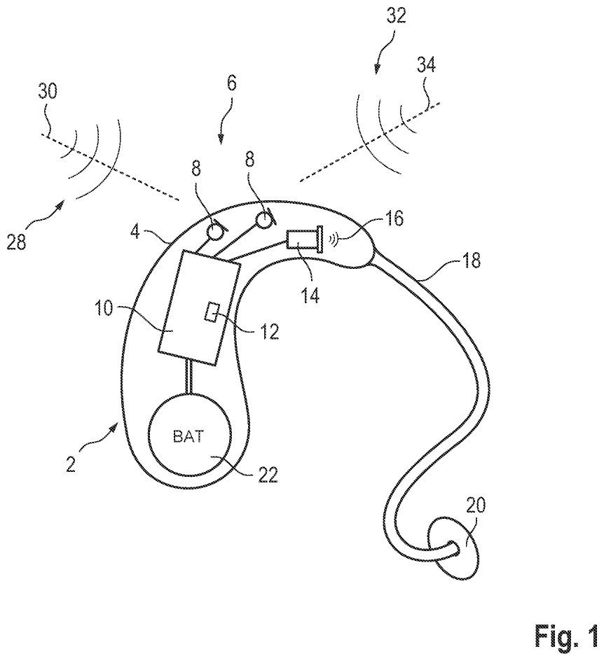

Referring now to the figures of the drawing in detail and first, in particular, to FIG. 1 thereof, there is shown hearing aid 2 in the form of a hearing aid device. The device is configured to be worn behind an ear of a user (user, hearing aid wearer, wearer). In other words, it is a behind-the-ear hearing aid device, BTE. The hearing aid 2 comprises a housing 4, which is manufactured from a plastic. A directional microphone 6 having two electromechanical sound transducers each in the form of an omnidirectional microphone 8 is arranged inside the housing 4. By changing a time delay between the acoustic signals acquired by means of the omnidirectional microphones 8, it is possible to change a directional characteristic of the directional microphone 6. The two microphones 8 are coupled for signaling to a signal processing unit 10, which comprises an amplifier circuit (not shown in greater detail) and a signal processor 12. The signal processing unit 10 is furthermore formed by means of circuit elements, for example electrical and/or electronic components. The signal processor 12 is a digital signal processor (DSP) and is connected for signaling to the microphones 8 via an A/D converter.

A receiver 14 is coupled for signaling to the signal processing unit 10. During operation, an (electrical) signal provided by means of the signal processing unit 10 is converted into an output sound 16, thus into sound waves, by means of the receiver 14. These soundwaves are introduced into a sound tube 18, one end of which is fastened on the housing 4. The other end of the sound tube 18 is enclosed by means of a dome 20, which is arranged in the intended state in an auditory canal of the user. The dome 20 includes multiple openings here, so that a wearing comfort is enhanced. The signal processing unit 10, the directional microphone 6, and the receiver 14 are powered by means of a battery 22.

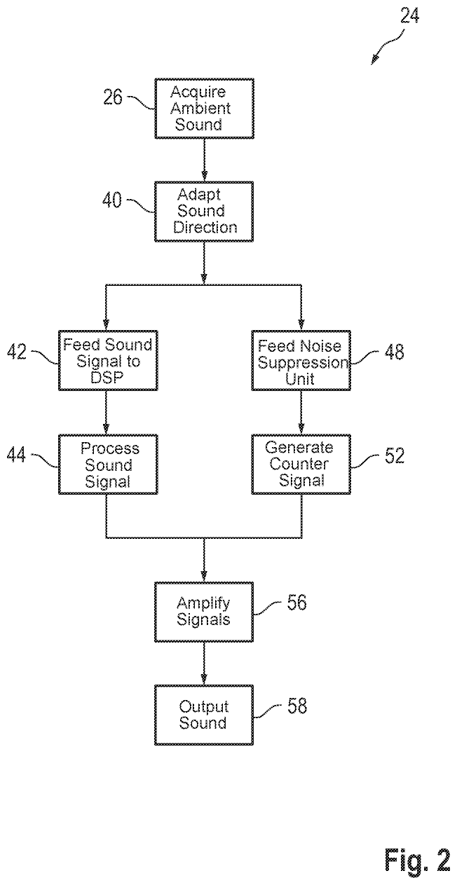

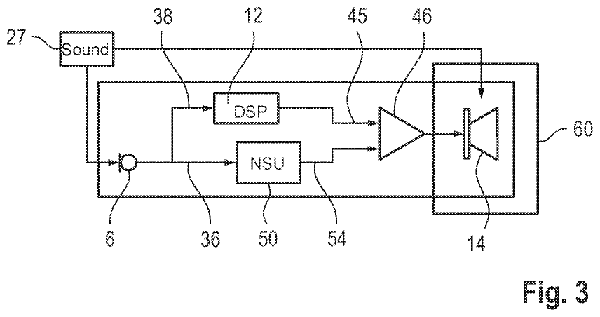

A method 24 for operating the hearing aid 2, the signal path of which is shown in FIG. 3, is illustrated in FIG. 2. In a first work step 26, an ambient sound 27 is acquired by means of the microphones 8. The ambient sound 27 includes sound 28 here which is incident on the directional microphone 6 from a preferred direction 30. Furthermore, the ambient sound 27 includes further sound 32, which is incident on the directional microphone 6 from a further preferred direction 34. The sound 28 is emitted here from an interference source and includes a specific frequency spectrum, namely, substantially only one single frequency, which is 50 Hz. The further sound 32, in contrast, is emitted by a further sound source, namely a further person.

The sound 28 and the further sound 32 are acquired by means of the microphones 8 of the directional microphone 6 and conducted to the signal processing unit 10. The signal processing unit 10 forms a part of the directional microphone 6, and by means of a corresponding time delay, the component corresponding to the sound 28, namely a sound signal 36, and a component corresponding to the further sound 32, namely an audio signal 38, are identified in the acquired signals which are acquired by means of the microphones 8.

In a subsequent second work step 40, the preferred direction 30, thus the direction from which the sound 28 is acquired by means of the directional microphone 6 to create the sound signal 36, is changed in dependence on the sound 28. The preferred direction 30 is changed here to the direction from which the sound 28 is primarily incident on the directional microphone 6. For this purpose, the maximum in the directional distribution in the case of the 50 Hz signal is ascertained and the preferred direction 30 is placed in this direction. Furthermore, the further preferred direction 34 is adjusted in such a way that it faces toward the further sound source. This is carried out manually or by means of a suitable algorithm, for example.

In a subsequent third work step 42, the further sound signal 38 is conducted to the signal processor 12. In a fourth work step 44, processing of the audio signal 38 is carried out by means of the signal processor 12. In this case, certain frequencies are amplified and others are damped. Furthermore, a compression is set. The audio signal 38 processed in this way is supplied as a further sound signal 45 to an amplifier 46 of the signal processing unit 10.

At the same time as the third work step 42, a fifth work step 48 is carried out. In this step, the sound signal 36 is supplied to an interference noise suppression unit (NSU) 50 of the signal processing unit 10. In a sixth work step 52, a counter sound signal 54, which is also conducted to the amplifier 46, is created by means of the interference noise suppression unit 50.

In a seventh work step 56, the further sound signal 45 and the counter sound signal 54 are amplified by means of the amplifier 46 and conducted in combined form to the receiver 14. By means of this, in an eighth work step 58, the amplified further sound signal 45 and the counter sound signal 54 are emitted as the output sound 16 through the sound tube 18 in an auditory canal 60 of the user.

Since the dome 20 is designed to be transmissive, the ambient sound 27, thus both the sound 28 and also the further sound 32, also reaches the auditory canal 60 essentially unobstructed. The sound 28 and the further sound 32 are superimposed in the auditory canal 60 with the output sound 16. Due to the amplifications of the audio signal 38 by means of the signal processor 12, constructive acoustic interference at least partially takes place here in the auditory canal 60, so that the further sound 32 is perceptible for the user. Because of the output of the counter sound signal 54, destructive acoustic interference of this component of the output sound 16 takes place with the sound 28. As a result, the sound 28 is essentially eliminated by means of the output sound 16. In other words, destructive acoustic interference takes place. The sound 28 is thus not perceptible or is only perceptible in a comparatively strongly reduced manner to the user. It is therefore not necessary to select the amplification of the audio signal 38 as comparatively high in the fourth work step 44, wherein nonetheless reliable perception of the further sound 32 is possible for the user either directly or on the basis of the components contained by means of the output sound 16. The counter sound signal 54 or the component of the output sound 16 based thereon only has the frequency of 50 Hz, so that the destructive acoustic interference takes place in a frequency-selective manner. It is thus possible for the user to perceive other sound sources besides the interference source from the preferred direction 30.

It will be understood that the invention is not restricted to the above-described exemplary embodiment. Rather, other variants of the invention can also be derived therefrom by a person skilled in the art without leaving the subject matter of the invention. In particular, furthermore all individual features described in conjunction with the exemplary embodiment are also combinable with one another in another way without leaving the subject matter of the invention.

The following is a summary list of reference numerals and the corresponding structure used in the above description of the invention:
2 hearing aid
4 housing
6 directional microphone
8 microphone
10 signal processing unit
12 signal processor, DSP
14 receiver
16 output sound
18 sound tube
20 dome
22 battery, BAT
24 method
26 first work step
27 ambient sound
28 sound
30 preferred direction
32 further sound
34 further preferred direction
36 sound signal
38 audio signal
40 second work step
42 third work step
44 fourth work step
45 further sound signal
46 amplifier
48 fifth work step
50 interference noise suppression unit, NSU
52 sixth work step
54 counter sound signal
56 seventh work step
58 eighth work step
60 auditory canal

1. A method of operating a hearing device, which includes a directional microphone, an interference noise suppression unit, and a receiver for outputting an output sound, the method comprising:
acquiring sound from a preferred direction by the directional microphone and conducting the sound to the interference noise suppression unit;
generating a counter sound signal by the interference noise suppression unit and conducting the counter sound signal to the receiver; and
outputting the counter sound signal as an output sound by way of the receiver;
wherein the counter sound signal is generated such that, upon superposition of the output sound with the sound acquired with the directional microphone, causes at least partial destructive acoustic interference.

2. The method according to claim 1, which comprises generating the counter sound signal to cause the destructive acoustic interference takes place in a frequency-selective manner.

3. The method according to claim 1, which comprises changing the preferred direction in dependence on the sound.

4. The method according to claim 1, which comprises simultaneously outputting a further sound signal by way of the receiver.

5. The method according to claim 1, which comprises operating a hearing aid device.

6. A hearing device, comprising:
a directional microphone;
an interference noise suppression unit;
a receiver for outputting an output sound; and
a processing unit configured to operate the hearing device according to the method of claim 1.

7. The hearing device according to claim 6, configured an operated as a hearing aid device.

8. A method of generating an output sound, the method comprising:
acquiring a sound by way of a directional microphone from a preferred direction;
generating a counter sound signal with a hearing aid to form an output sound and superimposing the output sound on the sound acquired by way of the directional microphone to cause at least partial destructive acoustic interference with the sound from the preferred direction upon superposition.
